(19) United States
(12) Patent Application Publication
(10) Pub. No.: US 2025/0388104 A1
(43) Pub. Date: Dec. 25, 2025

(54) METHOD FOR CONTROLLING OPERATION OF AN AUTONOMOUS CHARGING DEVICE BASED ON VEHICLE INLET FEATURES AND VEHICLE POSITIONING

(71) Applicant: Rocsys B.V., Rijswijk (NL)

(72) Inventors: Kanter van Deurzen, Delft (NL); Johannes Oosten van der Weijde, Delft (NL); Crijn Bouman, Rijswijk (NL)

(21) Appl. No.: 19/236,827

(22) Filed: Jun. 12, 2025

(30) Foreign Application Priority Data
Jun. 19, 2024 (NL) 2037995

(51) Int. Cl. B60L 53/37; B60L 53/16; B60L 53/36; B60L 53/66; G06T 7/70

(52) U.S. Cl. CPC B60L 53/37; B60L 53/16; B60L 53/36; B60L 53/66; G06T 7/70

(57) ABSTRACT

A method for controlling an autonomous charging device (ACD), the ACD configured to manipulate a vehicle charging connector and determine a pose of a vehicle charging inlet, and based on such pose determination, mating the charging connector into the vehicle charging inlet. The method comprises receiving information about the vehicle, wherein said information comprises at least one of an inlet feature parameter and a vehicle positioning parameter, acquiring at least one of a preset inlet pose determination strategy and a preset mating strategy by inputting the received vehicle information into a predetermined model, and controlling the ACD based, at least partly, on the acquired preset inlet pose determination strategy and/or preset mating strategy. The vehicle information can be received prior to a visual determination of the inlet pose.

### CROSS-REFERENCE TO RELATED APPLICATION

The present application claims priority from pending Netherlands Patent Application No. 2037995, filed Jun. 19, 2024, which is incorporated herein by reference.

The invention relates to a method and system for controlling the operation of an autonomous charging device based on vehicle inlet features and vehicle positioning information.

### TECHNICAL FIELD

The present invention relates to the field of autonomous charging systems for electric vehicles. Specifically, it pertains to methods, systems, and computer programs for optimizing the operation of autonomous charging devices (ACDs) by efficiently manipulating a vehicle charging connector.

### BACKGROUND

The surge in electric vehicle (EV) adoption has propelled a substantial demand for autonomous charging solutions, often referred to as autonomous charging systems or devices. Traditional approaches to vehicle charging often involve manual intervention, requiring drivers to physically connect charging cables to their vehicles.

Autonomous charging systems typically feature actuated robotic systems, mechanisms to support and manipulate a charging connector, and computer vision technologies. These technologies, often supported by neural networks and algorithms, enable the system to recognize the vehicle's charging inlet and facilitate the connection and disconnection of the charger to the vehicle inlet. Devices and related methods for this purpose are known in the state of the art, for instance from the international patent applications WO2020222640, WO2021167462, WO2022005281, WO2022045881, WO2022086320, WO2022234059, WO2023131577, WO2023227412, WO2024068806, WO2024133162A1, WO2023198456, NL2035240, NL2035932, NL2036719, all from the same applicant, all of which are herein incorporated by reference.

However, as the automotive industry transitions towards autonomy, there arises a need for automated charging solutions capable of efficiently executing the mating of the connector and the vehicle inlet based on actual features of the vehicle to be charged, including particular features of the charging inlet as well as on the parking of the vehicle, which may vary substantially from one site to another and affect the alignment and mating process. The present invention addresses these challenges.

### SUMMARY

In a first embodiment, the present invention provides for a method for controlling an autonomous charging device (ACD), the ACD configured to manipulate a vehicle charging connector and determine a pose of a vehicle charging inlet, and based on such pose determination, mating the charging connector into the vehicle charging inlet, the method comprising, by a controller, the following steps: Receiving information about the vehicle, wherein said information comprises at least one of an inlet feature parameter and a vehicle positioning parameter; Acquiring at least one of a preset inlet pose determination strategy and a preset mating strategy by inputting the received vehicle information into a predetermined model; and Controlling the ACD based, at least partly, on the acquired preset inlet pose determination strategy and preset mating strategy. As a non-limiting example of this embodiment, the information about the vehicle is received prior to a visual determination of the inlet pose. Visual determination of the inlet pose comprises the use of one or more images of the vehicle charging inlet in combination with a computer vision unit provided with suitable algorithms which enable the determination of the pose of the inlet.

According this first embodiment, acquiring an inlet feature parameter is desirable as it may enable the autonomous charging device to manipulate the charging connector towards the charging inlet taking into consideration actual physical features of the inlet. Likewise, acquiring a vehicle positioning parameter is desirable as it may enable the ACD to predict the location of the vehicle inlet, facilitating manipulation of the charging connector for engagement. In accordance with this embodiment, receiving information about the vehicle and controlling the ACD based on the determined inlet pose determination and mating strategy can enable in efficiently determining the pose of the charging inlet and performing the mating. This process is preferably intended to make necessary preparations and adjustments prior to a pose determination using visual means such the processing of an image from the inlet by a computer vision unit. Preferably, this process is not intended to replace a pose determination using such visual means.

Example and additional embodiments are described in the dependent claims.

### BRIEF DESCRIPTION OF THE DRAWINGS

FIG. 1 is a schematic diagram of an autonomous charging device according with one embodiment of the present disclosure.

FIG. 2 is a simplified structural block diagram of an autonomous charging device according to an embodiment of the disclosure.

FIG. 3A and FIG. 3B show a representation a vehicle charging connector and a vehicle charging inlet.

FIG. 4 shows a representation a vehicle charging inlet.

FIG. 5 is a flowchart illustrating a method for controlling an autonomous charging device according to an embodiment of the present disclosure.

FIG. 6 shows a flowchart illustrating an exemplary embodiment in accordance with the present disclosure.

FIG. 7 shows a simplified structural block diagram of a computing environment.

### DETAILED DESCRIPTION

Some existing systems have various shortcomings relative to certain applications. Accordingly, there remains a need for further contributions in this area of technology.

International Patent Application WO2023116667 describes a charging device comprising: a control structure, and a mechanical arm main body, which is provided with a force sensor and a charging plug, wherein the force sensor is used for collecting acting force information between a side face of a charging head and a charging port after the charging plug makes contact with the charging port; and the control structure can control the pose of the mechanical arm main body according to the acting force information, so as to insert the charging plug into the charging port. This document mainly relies on information obtained by force sensors to adjust its strategy for mating the connector into the inlet.

The present invention is described below with reference to the flowchart descriptions of the method, system, and apparatus according to embodiments of the present invention or block diagrams or flowcharts. It should be understood that each block in the flowchart descriptions or block diagrams and a combination of the flowchart descriptions or block diagrams may be implemented by, but not limited to, computer program instructions, for example, they may also be implemented by corresponding hardware. In the case of implementation based on the computer program instructions, these computer program instructions may be provided for a general-purpose computer, a special-purpose computer, an embedded processor, or a processor of another programmable data processing device to generate a machine, so that the instructions executed by a computer or a processor of another programmable data processing device create a member for implementing a specified function/operation in the flowcharts and/or blocks and/or one or more flowcharts.

It should be noted that these computer program instructions may also be stored in a computer readable memory that can instruct the computer or other programmable data processing devices to function in a particular manner, such that the instructions stored in the computer readable memory generate a member that includes an instruction of implementing a specified function or operation in the flowcharts or blocks or one or more flowcharts.

It should also be noted that these computer program instructions may also be loaded onto a computer or another programmable data processor, such that a series of operating steps are performed on the computer or another computer programmable processor, thereby generating computer-implemented processing. Therefore, the instructions executed on the computer or another programmable data processor provide steps for implementing a specified function or operation in the flowchart and/or one or more blocks in the block diagrams. It should be further noted that, in some alternative implementations, the functions or operations shown in the blocks may not take place according to the order shown in the flowcharts. For example, two blocks shown sequentially may be basically performed at the same time or the blocks may sometimes be performed according to a reverse order, which specifically depends on the functions/operations involved.

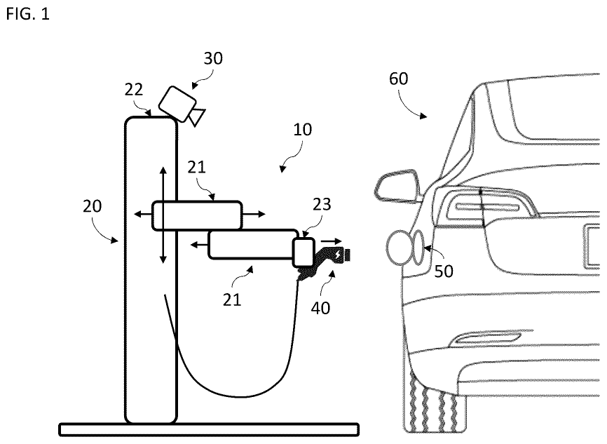

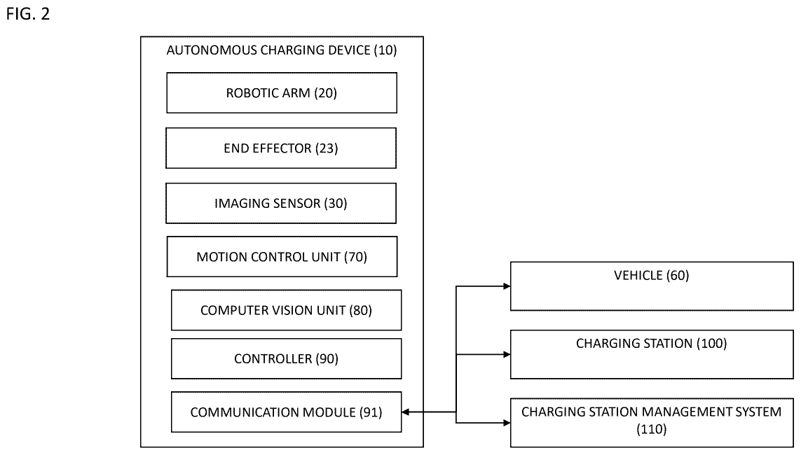

An autonomous charging device 10 according to an implementation of the present disclosure will be described below in conjunction with FIG. 1 and FIG. 2.

FIG. 1 is a diagram illustrating an autonomous charging device 10 for the autonomous connection of a vehicle charging connector 40 into a vehicle inlet 50 according to one embodiment of the present disclosure. In the context of the disclosure, the term “vehicle” or other similar terms is intended to mean a pure electric vehicle or a hybrid vehicle powered at least in part by a power battery. A hybrid vehicle is a vehicle with two or more power sources, such as a vehicle powered by a gasoline engine and an electric motor.

In reference to FIG. 1, a device 10 comprises a robotic system including a robotic arm 20 adapted to support a charging connector 40. The robotic arm 20, comprises one or more moveable sections 21 which enable the charging connector 40 to be translatable or rotatable along or around an axis in at least one to six degrees of freedom. An end-effector 23 can be positioned between a moveable section 21 and the charging connector 40. The end effector 23 may be a controllable actuated mechanism comprising means to support, either in a releasable manner or not, the vehicle charger connector 40.

FIG. 2 is a simplified structural block diagram of an autonomous charging device 10 according to an embodiment of the disclosure. In reference to FIG. 2, the autonomous charging device 10 further comprises, or is in communication with a motion control unit 70 which is configured to control the motion of the device 10 or a component thereof, such as the robotic arm 20 or the end effector 23 for, among others, mating the connector 40 into the vehicle inlet 50. The autonomous charging device 10 is set to support and manipulate the charging connector 40 in at least one, two, three, four, five or six degrees of freedom. In further reference to FIG. 1, when an electric vehicle 60 is to initiate a charging cycle, and after the vehicle is positioned in its vicinity, the device 10 is configured to determine a pose of the vehicle charging inlet 50, and at least based on that pose determination, manipulate the charging connector 40 towards the inlet 50 and mating the charging connector 40 into the vehicle inlet 50.

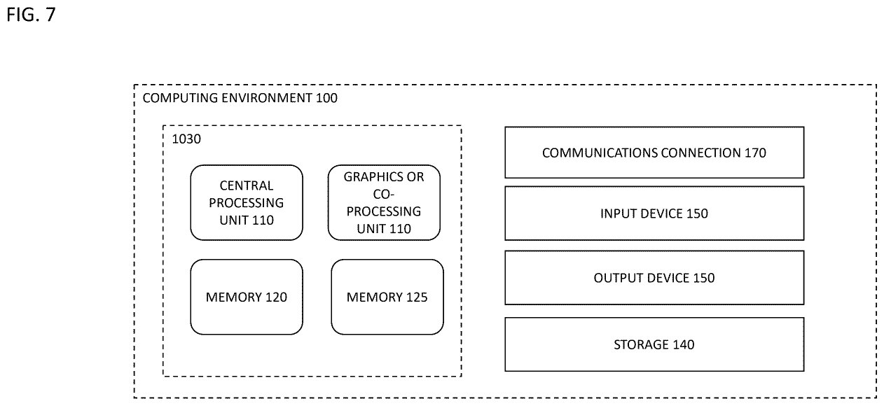

In reference to FIG. 2, the autonomous charging device 10 further comprises, or is in communication with a controller 90 which is configured to execute instructions in accordance with one or more of systems, flowcharts, methods, and/or processes described herein. The controller comprises, or is in communication with a computing environment as depicted in FIG. 7.

In reference to FIG. 1 or FIG. 2, the device comprises, or is in communication with, an imaging sensor, such as camera 30. In reference to FIG. 1, the camera 30 is fixed to a supporting surface 22 of the device 10 and can remain stationary relative to the motions of the robotic arm 20, the end effector 23, or the charging connector 40. Thereby, the camera 30 position remains substantially unchanged when the charging connector 40 is manipulated by the robotic arm 20. In some embodiments (not shown), the camera is fixed to a moveable section of the robot 21 or to the end effector 23. Thereby, the camera can be coupled to the movement moveable section 21, the end effector 23 or the charging connector 40. A controller 90 is configured to coordinate the processing of information, such as sensor information and to coordinate the motion and operation of the device 10 or any component thereof.

In reference to FIG. 2, the autonomous charging device comprises, or is in communication with, a computer vision unit 80 configured to determine a pose of the vehicle inlet 50 utilizing one or more images captured by the camera 30. In some embodiments, the autonomous charging device 10, by means of the computer vision unit 80, is configured to determine the pose of the vehicle inlet 50 by utilizing recognizable features visible in an image captured by the camera 30. The computer vision unit is preferably provided with a suitable neural network trained to determine the pose of an object through an analysis of one or more images. Recognizable features comprise features of the vehicle charging inlet, such as the inlet pins, inlet holes, inlet housing, inlet cover, inlet locking mechanisms and combinations thereof. Other recognizable features comprise a referential marker, such as a QR code, whose position or relative position to the vehicle inlet is known. As used in the present disclosure, the term “pose” refers to a spatial orientation in a three, four-, five-, or six-dimensional space of an object. Additionally, or alternatively, the pose may involve dimensions of information representing the object's position relative to the camera.

In reference to FIG. 2, in some embodiments, the autonomous charging device 10 is configured to determine the pose of the vehicle charging inlet 50 by receiving information about the pose of inlet 50, wherein such information is received from the vehicle 60, from a charging station 100 or from a charging station management system 110. Such information is transmitted through a communications module 91. Such information about the pose of the inlet 50 comprises at least one of accurate pose coordinates, estimated pose coordinates, and expected pose coordinates, in each case at any time or at a predetermined time.

In reference to FIG. 2, the autonomous charging device 10 comprises a communication module 91. The communication module 91 is configured to communicate with an external apparatus, for example, to receive state data about the vehicle 60, either from the vehicle 60, from a charging station 100, from a charging station management system 110, from a cloud service (not shown), from a remote management system (not shown) or from a combination thereof.

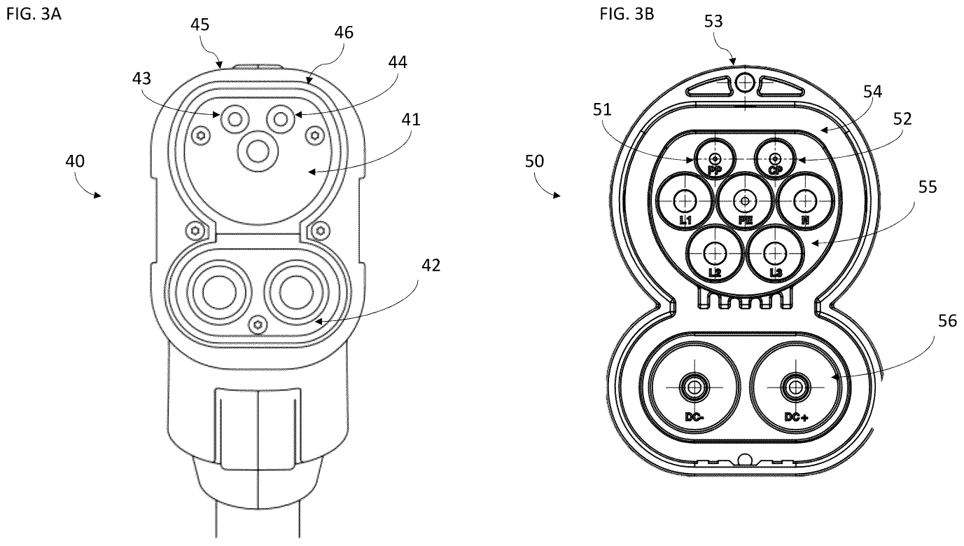

In reference to FIG. 3A and FIG. 3B, a charging connector 40 and a vehicle inlet 50 in accordance with one embodiment of the disclosure are depicted.

Referring to FIG. 3A, the charging connector 40 comprises a housing 45, and an insulating and guiding body 46. The charging connector 40 and charging inlet 50 include an AC connector section 41, 55, respectively, arranged at the top section and a DC connector section 42, 56, respectively, arranged at the bottom section, each with a plurality of plug contacts 43, 44 that correspond to a plurality of connectors 51, 52 in FIG. 3B and are adapted to connect with each other. In reference to FIG. 3B, the vehicle charging inlet 50 comprises a housing 53 and an insulating and guiding body 54. In these non limiting examples, pins 43 and 52 correspond to the control pilot and pins 44 and 51 correspond to the proximity pins.

It is to be understood that the number and arrangement of the plug contacts (or pins) illustrated in FIG. 3A and FIG. 3B are only used as example for explaining the principles of the present disclosure, rather than to limit the scope of the present disclosure. A charging connector according to one implementation of the present disclosure is configured to charge an electric vehicle using only AC current, or combination of AC and DC current, as depicted in FIGS. 3A and 3B. The plurality of pins may include at least one of a signal pin, an AC line pin, a neutral pin, a control pilot pin, a proximity detection pin, a ground pin. The plurality of pins may also include a DC positive pin and a DC negative pin.

A charging inlet typically incorporates various features contributing to its design and functionality. These features, referred to herein as inlet feature parameters are information which may be acquired by the ACD prior to a charging cycle as described in the first embodiment. As used herein, an inlet feature parameter includes but is not limited to: at least one inlet descriptive parameter and optionally a value or interval for such inlet descriptive parameter. In particular, an inlet feature parameter includes but is not limited to at least one of the following: an inlet position within the vehicle; an inlet orientation relative to the vehicle; an opening status of the inlet cover; an opening direction of the inlet cover; an opening angle of the inlet cover; a workspace within an inlet housing for manipulation of the charging connector; a dimension of the inlet cover; a volume surrounding the inlet in which the charging connector may be manipulated without encountering an obstacle; current coordinates of the inlet; intended or future coordinates of the inlet.

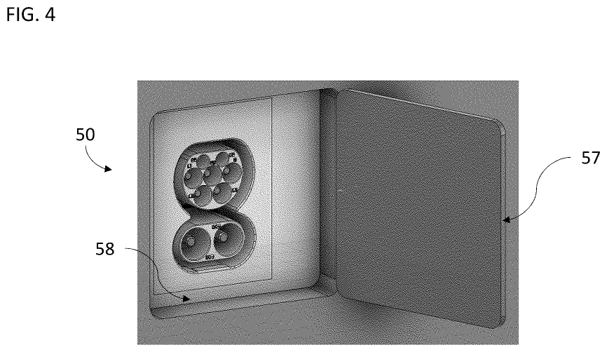

In reference to FIG. 4, a vehicle inlet 50 in accordance with an exemplary embodiment of the disclosure is depicted. Inlet features depicted are inlet cover 57 and workspace within the inlet housing for manipulation of the charging connector 58, as some non-limiting examples.

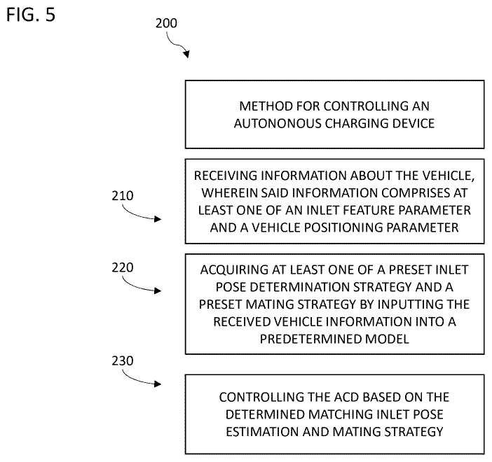

A method 200 for controlling an operation of an autonomous charging device (ACD) will be described below in conjunction with FIG. 5. When used herein, mating and unmating comprise the processes of connecting and disconnecting, respectively, the charging connector 40 with or from the vehicle charging inlet 50 as well as any necessary preparations therefor. Mating comprises the alignment and engagement of the charging connector with the vehicle inlet for the transfer of electrical energy during the charging cycle. Unmating comprises the disengagement and disconnection of the charging connector from the vehicle inlet once the charging cycle is complete.

FIG. 5 is a brief flowchart of the method 200 according to an embodiment of the present disclosure. In further reference to anyone of FIG. 1 to FIG. 4, the method 200 comprises, by a controller: step 210 comprising: receiving information about the vehicle, wherein said information comprises at least one of an inlet feature parameter and a vehicle positioning parameter; step 220 comprising acquiring at least one of a preset inlet pose determination strategy and a preset mating strategy by inputting the received vehicle information into a predetermined model; step 230 controlling the ACD based, at least partly, on the acquired preset inlet pose determination and preset mating strategy. In accordance with the present invention, the information about the vehicle is received prior to a visual determination of the inlet pose. Thereby, preparation steps can be taken prior to a visual determination of the inlet pose in order to determine the preferred means to make such determination and to execute the mating.

The specific details of each of the process steps and preferred realizations are described in the following.

Step 210 comprising receiving information about the vehicle may be accomplished through various means. The autonomous charging device 10 may receive information about the vehicle, either directly from the vehicle, from a charging station, or from a site-, fleet- or charging-station management system (in general referred to as management system), in each case utilizing suitable communication means. Communication means include but are not limited to wireless communication protocols, data exchange interfaces, or network connections. Wireless communication protocols include wireless protocols, such as Wi-Fi, UWB, Bluetooth, Bluetooth Low Energy, 3G, 4G, 5G, and/or near field communication (NFC) protocols, as some non-limiting examples. In some embodiments, information about the vehicle may be pre-stored in the ACD, in a charging station or in a management system in communication therewith, and in each case such information may be determined based on historical data, prior knowledge of vehicle behavior, prior knowledge of vehicle inlet features, prior knowledge of vehicle positioning features, or utilizing a combination of sources of information as described herein. Thereby, receiving information about the vehicle does not necessarily require a communication from the vehicle at each instance, as the ACD may already possess or access relevant data.

As used herein, an inlet feature parameter includes but is not limited to at least one inlet descriptive parameter and optionally a value or interval for such inlet descriptive parameter. The inlet feature parameter can include at least one of: an inlet position within the vehicle, an inlet orientation relative to the vehicle, an opening status of the inlet cover; an opening direction of the inlet cover; an opening angle of the inlet cover; a workspace within an inlet housing for manipulation of the charging connector; a dimension of the inlet cover. Moreover, the inlet feature parameter can comprise a volume surrounding the inlet in which the charging connector may be manipulated without encountering an obstacle. The inlet feature parameter can include current coordinates of the inlet and intended or future coordinates of the inlet.

Receiving information about an inlet feature parameter is desirable as it can enable the autonomous charging device to identify a suitable strategy for manipulate the charging connector towards the charging inlet, enabling a mating. In an exemplary embodiment, the inlet feature parameter is the inlet position within the vehicle, specified as coordinates (x, y, z) relative to a reference point on the vehicle. For instance, the inlet might be located at coordinates (1.2, 0.5, 0.3) meters from the front-left corner of the vehicle. In an exemplary embodiment, the inlet feature parameter is the opening angle of the inlet cover, specified as an angle in degrees. For example, the inlet cover might open at an angle of 90 degrees with an opening direction to the left (counterclockwise when viewed from the front of the vehicle). Another example of an inlet feature parameter might include the inlet orientation relative to the vehicle, such as the inlet being positioned at a certain angle in relation to the fixed world. For example, the inlet could be oriented at 45 degrees relative to the horizontal plane of the vehicle.

Likewise, receiving information about a vehicle positioning parameter is desirable as it can enable the ACD to anticipate a position of the vehicle inlet, facilitating a determination of the pose of the inlet for enabling the mating. As used herein, the vehicle positioning parameter comprises at least one of the following: a vehicle position coordinate data, such as parking coordinate information; an inlet position coordinate data; an accuracy parameter representing an accuracy of the vehicle or inlet position coordinate data; a metadata of the vehicle or inlet position coordinate data; and a combination thereof. A metadata includes additional contextual information about the vehicle or inlet position, such as a timestamp of when a coordinate data is recorded, the source or method used to obtain the data (e.g., GPS), and any relevant conditions or events at the time of measurement (e.g., weather conditions, vehicle state). Such metadata can be expected data. For example, if the EV is expected to park in the vicinity of the ACD for a planned charging session, the EV may provide parking information to the ACD in advance so that the ACD can anticipate the vehicle's position and prepare for the charging process accordingly.

The vehicle positioning parameter may be the vehicle position coordinate data, such as the GPS coordinates of where the vehicle is parked. For example, the vehicle might be parked at coordinates (XX.XXX N, YY.YYY° W) and an accuracy parameter representing the accuracy of the vehicle's position indicates that GPS data might have an accuracy of about +0.5 meters. Another example of a vehicle positioning parameter might include the inlet position coordinate data, such as the coordinates (x, y, z) of the vehicle's inlet in relation to such parking coordinates. For instance, the inlet may be located at coordinates (2.0, 1.5, 0.5) meters from a reference point in the parking bay or from an ACD reference point. Metadata of the vehicle position, such as the timestamp of when the vehicle was parked might also be included, such as the vehicle might have parked at HH:MM on MM:DD:YYYY.

A predetermined model in accordance with the present disclosure may consider ACD intrinsic and extrinsic parameter which may influence each of the strategies. ACD intrinsic parameters include but are not limited to camera parameters, charging connector range of motion, compliance parameters, force thresholds and others. ACD extrinsic parameters include but are not limited to weather conditions, light source, light conditions, light direction, geographic location, and others.

In further reference to FIG. 5, the method comprises step 220 comprising: Acquiring at least one of a preset inlet pose determination strategy and a preset mating strategy by inputting the received vehicle information into a predetermined model. A preset mating strategy encompasses various approaches to execute the mating process of the charging connector into the vehicle inlet. As used herein mating strategy comprises not only a strategy to be utilized during mating, but also while the connector is mated and when the connector is unmated from the inlet.

The predetermined model can preferably be a model generated by training, configuration, or instruction, which may take the form of a neural network model, algorithm, look-up table, or any other suitable method. The output of the predetermined model comprises at least one of a preset inlet pose determination strategy and a preset mating strategy. The predetermined model is preferably a previously generated model, but can also be dynamically updated or adjusted based on real-time data or conditions encountered during operation. The predetermined model can be stored in the ACD processor or can be executed remotely via cloud computing services. For example, the ACD may utilize cloud-based resources to access and execute updated versions of the predetermined model.

Each of a pose determination strategy and a mating strategy can include instructions which can, for example, optimize such inlet pose determination and such mating. As used herein, optimizing the inlet pose determination comprises achieving a reliable determination of the vehicle's charging inlet position and orientation in an efficient manner, while utilizing available resources effectively. Preferably, the inlet pose determination and mating are made in a shorter time frame than the time it would be required if the ACD did not have knowledge of the inlet features or vehicle positioning parameters.

By utilizing a predetermined model capable of defining an inlet pose determination strategy or a mating strategy, based on a received vehicle information, the method can optimize the control of the ACD, thereby improving the pose determination and mating processes. Improved pose determination and mating can reduce the risk of damaging either the vehicle charging inlet or the charging connector, which prevents the need for accurate detection of obstacles near the inlet. Furthermore, an improved pose determination can accelerate the determination of the inlet pose, leading to a faster connection and charging of the vehicle. An optimized pose determination strategy and mating strategy adapted to actual data of the vehicle can enable the ACD to prevent system failures and errors, bypass obstacles, position itself appropriately, and approach the inlet from a specific direction or orientation, where required. Furthermore, it is possible for the ACD to adjust the control strategy to reduce the risk that a fault occurs when the connector is approaching the inlet. In some cases, receiving vehicle information may allow predicting a feature of the vehicle. For example, the predetermined model may predict the pose of the vehicle charging inlet based on previous interactions with similar vehicles or data points, or anticipate potential obstructions or misalignments, enabling a more reliable and efficient charging process, minimizing downtime. Alternatively, the output of the predetermined model comprises the means for the ACD to define at least one of a preset inlet pose determination strategy and a preset mating strategy. It is noted that the above example is illustrative and may not be a limitation of the predetermined model in embodiments of the disclosure. In the present disclosure, the term “optimization” is not intended to achieve a maximum performance or an error free process, but is rather intended to indicate more general improvements in operation, such as in charging speed, alignment accuracy, energy efficiency, and user satisfaction.

According to an example embodiment, the predetermined model may be a statistical model, or a machine learning model trained with vehicle information data from the vehicle or from a plurality of vehicles. Thus, various types of predetermined models are conceivable. A simple form of model is a look-up table type model, however, what could be a more exhaustive and accurate model is based on a machine learning algorithm that can be continuously improved using additional vehicle information. The machine learning algorithm may be for example a supervised or unsupervised machine learning algorithm. Generally, the machine learning algorithm may be selected based on the specific implementation at hand. More preferably, a supervised machine learning regression algorithm can be used in the methods of the present invention. Such algorithms include, but are not limited to, decision tree algorithms, support vector machines, and Gaussian process regression algorithms. According to an example embodiment, the predetermined model may be trained in order to improve or optimize one or more operational parameters of the ACD, such as pose determination and mating performance, downtime performance, charging efficiency, and safety protocols.

A predetermined model in accordance with the present disclosure comprises a discrete function, for example in the form of a look-up table, or a continuous function, whereby obtained vehicle data is used as input to determine a strategy, in particular a preconfigured strategy. For example, based on vehicle inlet position and orientation with respect to the vehicle as inlet feature parameter, in combination with the intended positioning (parking) position as vehicle positioning parameter, the ACD may anticipate the position and orientation of the inlet. Such anticipation can define and facilitate the determination of the pose of the inlet and subsequent mating.

A discrete or continuous function may be updated over time as more data is collected, allowing for continuous improvement in the ACD's performance. For instance, a look-up table can store data on various inlet feature parameters such as the position of the inlet within the vehicle, its orientation, cover opening direction, and dimensions. Additionally, a discrete or continuous function can store vehicle positioning parameters such as coordinates relative to the ACD, the accuracy of positioning, and descriptions of the volume surrounding the vehicle inlet. When the ACD receives new vehicle information, it can reference the look-up table to find the most similar historical data points. The model can then extract the inlet pose determination strategy and mating strategy that were successful for similar vehicles or conditions. For example, if the vehicle's inlet position and orientation match closely with a previous entry in the look-up table, the model can apply the same pose determination and mating strategies that were effective in that instance. Moreover, a look-up table may be automatically or manually adjusted by preconfigured preferred settings for specific vehicles or vehicle types, charging conditions, or other requirements. Moreover, the look-up table can incorporate preferred settings for certain inlet parameters and vehicle positioning parameters, and adjust strategies based on different charging conditions (such as ambient temperature, lighting conditions or battery state of charge), or modify approaches to meet specific user requirements or operational constraints.

In further reference to FIG. 5, the method comprises step 230 comprising: Controlling the ACD based on the determined preset inlet pose determination and mating strategy. This step comprises executing actions and adjustments to align and mate the charging connector with the vehicle inlet. The ACD uses the inlet pose determination strategy to identify and approach the vehicle's charging inlet. Subsequently, it employs the mating strategy to guide the charging connector into the inlet.

Preset inlet pose determination and mating strategies may be updated based on results from previous charging cycles. Historical vehicle information, and learned patterns may be stored and may be accessed to determine the most suitable or optimal inlet pose determination strategy and mating strategy.

The predetermined model can output instructions to execute the pose determination strategy and the mating strategy consecutively, simultaneously, alternated, or in any combination thereof. For example, in a preferred realization, the predetermined model may first execute the pose determination strategy to establish how to determine the position and orientation of the vehicle's inlet relative to the ACD. Subsequently, once the pose has been determined, it may initiate the mating strategy to manipulate the charging connector into the inlet. Such mating strategy may include manipulating the connector to avoiding certain obstacles, such as an opened flap.

The inlet feature parameter and a vehicle positioning parameter can be received consecutively, simultaneously, alternated, or in any combination thereof. For example, the inlet feature parameter could be received first to determine the dimensions and orientation of the inlet, followed by the vehicle positioning parameter to ascertain the location of the vehicle relative to the ACD. Alternatively, both parameters could be received simultaneously.

After executing the pose determination strategy or the mating strategy, further vehicle information can be received and a new pose determination strategy or the mating strategy can be acquired. In some cases, the mating strategy can be adjusted as a result of the inlet pose determination strategy, and vice versa.

In an exemplary embodiment, a preset inlet pose determination strategy comprises adjusting a camera parameter as a function of the received vehicle information, wherein the camera parameter comprises a camera field of view, camera position, a camera orientation, a camera focus, a camera exposure, a camera zoom, and a combination thereof. This allows the ACD to, for example, change the area it focuses on, capturing relevant visual data for inlet pose determination. The ACD may anticipate the position and orientation of the vehicle inlet based on received vehicle information and adjust the camera parameters so that the vehicle inlet will be in view and/or focus of the camera. Such adjustment enables the ACD to determine the inlet pose requiring less iterations of adjusting camera parameters and determining the inlet pose.

In an exemplary embodiment, a preset inlet pose determination strategy comprises moving the camera closer to the anticipated inlet position to get the inlet in view and/or in focus of the camera, without doing or attempting a prior pose detection by the computer vision module, where the anticipated inlet position is a determination based on received vehicle information. In particular, moving the camera from a distance larger than a first anticipation threshold to a distance smaller than a second anticipation threshold. More in particular, the first anticipation threshold is preferably a distance of about 4 meters, more preferably a distance of about 1.5 meters, even more preferably a distance of about 0.75 meter, and most preferably a distance of about 0.5 meter. Alternatively more in particular, the second anticipation threshold is preferably a distance of about 1.5 meters, more preferably a distance of about 0.75 meter, even more preferably a distance of about 0.5 meter, and most preferably a distance of about 0.3 meter.

In an exemplary embodiment, a preset inlet pose determination strategy comprises conducting an inlet pose determination with the camera positioned at a first distance relative to the inlet; and conducting a second inlet pose determination with the camera positioned at a second distance relative to the inlet wherein the second distance is smaller than the first distance. Thereby, the system can utilize one or more images of the vehicle inlet to determine the pose of the inlet. A first image may provide an initial approach to the pose of the inlet and a subsequent one may provide a more accurate inlet pose determination.

In an exemplary embodiment, preset inlet pose determination strategy comprises adjusting a number of inlet pose determination steps required by the computer vision unit when the vehicle positioning parameter is above or within a determined threshold. Normally, the computer vision unit would require at least two images of the inlet taken from different camera positions in order to achieve a reliable inlet pose determination prior to initiating the mating. By adjusting the number of pose determination steps, for example, by reducing them, the system can better utilize computational resources and reducing processing time when the vehicle information provides an indication of an expected pose of the inlet.

In an exemplary embodiment, preset inlet pose determination strategy comprises determining the inlet pose based on the vehicle positioning parameter and overriding one, more than one or all inlet pose determination steps required by the computer vision unit when the vehicle positioning parameter is above or within a determined threshold. For example, if the vehicle positioning parameter indicates an expected vehicle inlet pose with high confidence level with an accuracy parameter within a few centimetres, the system may bypass the initial inlet pose determination steps and proceed directly to a fine inlet pose determination.

A determined threshold may correspond to a minimum level of confidence or accuracy associated with the vehicle positioning parameter, such as a confidence score, coordinate accuracy within a predefined spatial tolerance (e.g., +2 cm). On the other hand, when the vehicle positioning parameter falls out of the determined threshold, such as when the inlet position data lacks sufficient accuracy, is outdated, or contains low-confidence metadata, system may increase the number of inlet pose determination steps to compensate for the uncertainty.

For example, a vehicle positioning parameter may include coordinate data indicating that the inlet is expected to be located at position (x=1.25 m, y=0.45 m, z=0.65 m) relative to a reference point on the ACD, with an associated accuracy parameter of +1.5 cm. If the system is configured with a threshold accuracy of +2.0 cm, this value would be within the threshold, allowing the system to reduce or bypass certain inlet pose determination steps. In another example, a confidence score may be provided as part of the positioning metadata, such as a score of 92% on a scale from 0% to 100%, with a defined threshold of 90%. If the reported score meets or exceeds this threshold, the system may rely on the positioning data to initiate a fine pose alignment directly. On the other hand, if the accuracy parameter is ±4 cm or the confidence score falls below 85%, the system may initiate additional visual verification steps to refine the inlet pose and compensate for uncertainty.

In an exemplary embodiment, preset mating strategy comprises pre-positioning the charging connector in relation to the vehicle inlet based on the inlet feature parameter. For example, the ACD may utilize information about the vehicle inlet's characteristics, such as its position, orientation, and dimensions, to proactively position the charging connector for alignment before the mating process begins. Thereby, the system may reduce the need for extensive adjustment during mating.

In an exemplary embodiment, the preset mating strategy comprises positioning the connector based on an anticipated inlet position, such as manipulating the connector close to an anticipated inlet position, where the anticipated inlet position is a determination based on received vehicle information, such as vehicle parking information. In such a case, anticipated inlet position is made without prior use of a preset inlet-pose determination strategy. The preset mating strategy can comprise moving the connector from a distance larger than a first anticipation threshold to a distance smaller than a second anticipation threshold. A first anticipation threshold may be a distance of about four meters (for example, in cases where the ACD is mounted over a long rail). A first anticipation may be a distance of about 1.5 meters; which is roughly the wingspan of an ACD for a larger mating space, whereby the ACD will be moving from one end to the other, or moving from a mating space on one side of the ACD to another side of the ACD. A first anticipation threshold may be a distance of about four meters; for example, in cases where the ACD is mounted on a long rail with queuing, or a scenario at a loading dock. A first anticipation threshold may be a distance of about 1.5 meters, of about 0.75 meter, and most preferably a distance of about 0.25 meter. Alternatively more in particular, the second anticipation threshold is preferably a distance of about 1.5 meters, more preferably a distance of about 0.75 meter, even more preferably a distance of about 0.5 meter, and most preferably a distance of about 0.25 meter.

In an exemplary embodiment, a preset mating strategy comprises instructions adapted to optimize the mating of the charging connector into the vehicle inlet, wherein the optimization of the mating of the charging connector into the vehicle inlet is performed using an algorithm which evaluates parameters comprising at least one of the inlet pose determination strategy, inlet pose, and inlet feature parameter, and wherein the function is adapted to iteratively refine the mating strategy to achieve an optimal mating performance.

In an exemplary embodiment, a preset mating strategy comprises adapting the mating strategy based on the accuracy of positioning information obtained from the EV. For example, if the positioning information indicates a high level of accuracy, the mating strategy may prioritize faster and more direct mating and force application towards the vehicle inlet, optimizing the charging process. On the other hand, if the accuracy of the positioning information is lower, the system may implement a slower and more controlled connector movements to enable alignment and avoid potential collisions or misalignments.

In an exemplary embodiment, a preset mating strategy comprises orienting the charging connector based on an inlet positioning coordinate information at a moment prior to the mating. For instance, the ACD may utilize inlet positioning coordinate information provided by the vehicle prior to the mating process to orient the charging connector accordingly. This may enable the ACD to anticipate the orientation for mating based on the anticipated positioning of the vehicle's inlet. For example, when the vehicle communicates ahead of time its planned positioning, such as when approaching a charging station for planned charging, the ACD can adjust the orientation of the charging connector to align with the expected location and angle of the vehicle's inlet.

In an exemplary embodiment, comprises activating passive or active compliance mechanisms of the ACD to compensate for misalignments and unexpected vehicle movements during the mating process. For example, if the vehicle inlet parameter indicates a partly obstructed inlet cover, the system may engage compliance mechanisms to accommodate the obstruction and enable mating.

In some embodiments, a preset mating strategy can be adjusted as a result of the inlet pose determination strategy, and vice versa. For example, if the inlet pose determination strategy indicates a significant deviation from the expected position or orientation of the vehicle's inlet, the mating strategy can be adjusted to compensate for this discrepancy. Conversely, if the ACD encounters opposing forces during the mating process, such as encountering an obstruction or experiencing misalignments, the inlet pose determination strategy may be refined to conduct a new determination of the pose of the inlet.

In an exemplary embodiment, a preset mating strategy comprises at least one of positioning the charging connector based on a position of the vehicle inlet cover, positioning the charging connector based on an opening direction of the vehicle inlet cover, or positioning the charging connector based on the presence of obstacles present within a volume surrounding the vehicle inlet. For example if the vehicle inlet cover is closed, the mating strategy may include positioning the charging connector in anticipation of the cover's opening direction.

In an exemplary embodiment, a preset mating strategy comprises selecting a path towards aligning the connector and inlet, based on received inlet feature parameters. In particular, the ACD may avoid moving the connector to the side where it anticipates obstacles to be present, for example avoiding moving ACD components too much to the right if the inlet cover opens to the right. Alternatively it may determine its path to align connector and inlet while avoiding bodywork of the vehicle.

In an exemplary embodiment, a preset mating strategy comprises a method to open an inlet cover, based on received inlet feature parameters. In particular, a method to open an inlet cover may comprise pressing on the cover to let it pop open, and subsequently fully opening the cover by pulling on the cover, where the ACD follows a predetermined path.

In an embodiment of the invention, a preset mating strategy comprises opening of the inlet cover, which may be followed by a preset pose-detection strategy to more precisely determine the pose of the charging inlet to allow for the mating of the connector into the inlet.

In an embodiment of the invention, a preset pose-determination strategy may comprise selecting a position and orientation of the ACD's camera with respect to the vehicle inlet, based on received inlet feature parameters.

In an embodiment of the invention, a preset mating strategy may comprise selecting a force-reduction strategy, based on received inlet-feature parameters. In particular, an ACD may use a look-up table to determine previously successful mating strategies for the type of vehicle or specific vehicle to be served (or inquire about this information with a management system), where the mating strategy comprises a force-reduction strategy.

In an embodiment of the invention, the method comprises providing positioning instructions to the vehicle based on the at least one of the inlet pose determination strategy and a mating strategy, such instructions comprising adjusting the vehicle's position to facilitate an alignment between the inlet and the charging connector. For example, if the vehicle's inlet is slightly misaligned with the charging connector, the system may provide positioning instructions to the vehicle to adjust its position accordingly. This adjustment could involve slight movements forward, backward, left, or right to facilitate alignment between the inlet and the charging connector.

In an embodiment of the invention, the method comprises providing a communication to be received by the vehicle comprising a position of the ACD, or any component thereof, within a clearance space, wherein the clearance space comprises a volume relative to the ACD in which a presence of the vehicle, or a part thereof, is restricted at a specific time. The clearance space is preferably a space where a portion of the ACD, such as the manipulator and connector can be present in order to complete the mating once the vehicle has parked in a designated parking area. The ACD can inform the vehicle about its position in relation to such clearance area, so that, for example, the vehicle can safely drive in or drive out of such clearance area. For example, if the ACD has extended its connector arm into the mating space to prepare for a charging operation, it may communicate to the vehicle that a zone within 0.5 meters in front of the connector must remain unoccupied for a defined period, until the mating preparation is complete.

In an embodiment of the invention, the method comprises providing a communication to be received by the vehicle comprising a mating space of the ACD, the mating space comprising a volume relative to the ACD where the ACD is able to mate the connector into the inlet. In an example, the ACD provides the vehicle with information on its mating space or spaces (with or without limited ranges of orientations). This information may be vehicle dependent. The vehicle may then inform the ACD of its intent on where to position its inlet, and park such that the inlet is within the intended mating space, such that the ACD is able to perform mating, in particular with a preferred mating strategy. For example, if the ACD defines a mating space extending 0.75 meters laterally and 0.5 meters vertically from its base, and is capable of mating only when the inlet is oriented between 30° and 90° relative to a horizontal plane, it may transmit these constraints to the vehicle. The vehicle can then select a parking position and inlet orientation—based on its configuration and maneuverability.

In an exemplary embodiment, the preset mating strategy comprises adapting a mating motion based on an accuracy parameter representing the accuracy of the vehicle or inlet position coordinate data. When the accuracy parameter exceeds a predetermined threshold, such as when the inlet position is known with a tolerance of +1 cm, the mating motion may be optimized for speed and efficiency, employing a more direct or faster insertion trajectory. On the other hand, if the accuracy parameter indicates a higher degree of uncertainty, e.g., a tolerance greater than +3 cm, the mating motion may be adapted to proceed more slowly or in a segmented manner.

In an embodiment of the invention, the method comprises providing information to be received by the vehicle or a management system, the information comprising coordinates of infrastructure-based markers with respect to the mating space, in particular the markers comprising radio tags or antennas, or visual markers, more in particular antennas for UltraWideBand.

In some cases, the method comprises receiving a mating request from the vehicle, wherein such mating request is received prior to, together with, or subsequent to, receiving the information about the vehicle.

In some cases, the method comprises performing a compatibility check between the inlet feature parameter, the positioning parameter, and ACD parameters, and providing a communication to be received by the vehicle if any incompatibilities or issues are detected. If the compatibility check results are negative, indicating that parameters do not align within predetermined parameters from the ACD, the system is configured to generate a communication to be received by the vehicle rejecting the charging request.

For example, if the inlet feature parameter indicates a position or orientation that does not match the ACD's capabilities, or the vehicle positioning parameter suggests that the vehicle is not properly aligned for charging, the system can send a communication to the vehicle indicating the rejection of the charging request and providing instructions for corrective actions.

For instance, if the inlet feature parameter indicates that the vehicle's inlet cover opens upwards at an angle of about 90 degrees, but the ACD is configured to operate only within a vertical clearance higher than 120 degrees due to structural constraints, the system identifies this as an incompatibility. Similarly, if the positioning parameter shows that the vehicle has parked with a lateral offset of more than 0.5 meters from the expected position, outside the ACD's lateral reach, the compatibility check may fail. In either case, the ACD transmits a communication to the vehicle indicating that the current configuration does not support safe or feasible charging, and may include guidance such as repositioning the vehicle, closing the inlet cover, or redirecting to a compatible charging station.

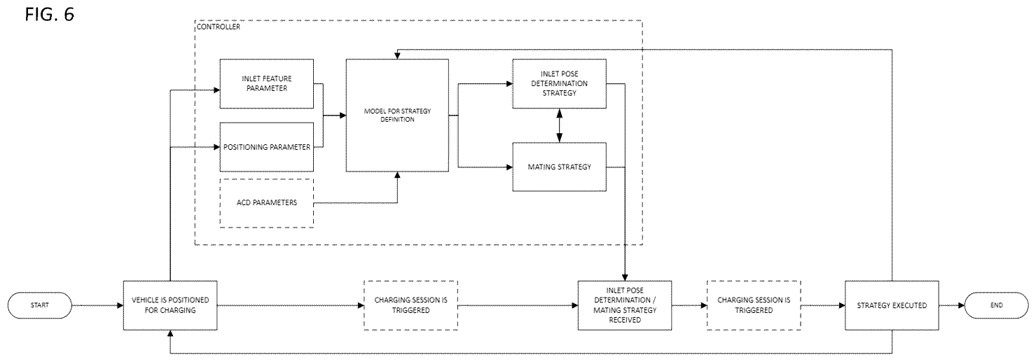

In an exemplary embodiment, the ACD may comprise a mechanism to pick-up and release charging connectors. In such an embodiment, the preset mating strategy may comprise moving the ACD to a parking spot prior to the EV being parked in said parking spot such that the ACD is able to perform mating, and the ACD picking up a charging connector suitable for the EV in anticipation of its parking. FIG. 6 conceptually illustrates an exemplary embodiment of the present disclosure. The ACD is designed to control the charging process by manipulating a vehicle charging connector and determining the pose of a vehicle charging inlet. In this non limiting exemplary embodiment, the process begins when the vehicle is positioned for charging, but in other embodiments the process may start before the vehicle is positioned for charging, such as when a approaching the ACD or when travelling to an ACD station. The ACD receives vehicle information such as inlet feature parameter and vehicle positioning parameters. The inlet feature parameter may comprise details about the vehicle's charging inlet such as its position within the vehicle, orientation, cover opening direction, and dimensions. The positioning parameter includes data regarding the vehicle's position relative to the ACD, such as coordinates and the accuracy of this positioning. These parameters are input into a model for strategy definition. In this non limiting exemplary embodiment, the model also receives ACD parameters, such as the type of connector which the ACD is equipped with. Additionally, relevant ACD parameters are considered, such as camera settings, status of compliance mechanisms, and others. The model, based on such received information and historical data and learned patterns generates at least two main outputs: an inlet pose determination strategy, and a mating strategy. Once the vehicle is positioned, and the charging session is triggered, the ACD is controlled, at least in part by execution of such strategies. In certain cases, vehicle information may be received subsequently and a new strategy may be defined which can be subsequently executed by the ACD. Moreover, both strategies can be dependent on each other and be adjusted as a result of the execution of each other.

FIG. 7 depicts a generalized example of a suitable computing environment 100 in which the described innovations may be implemented. The computing environment 100 is not intended to suggest any limitation as to scope of use or functionality, as the innovations may be implemented in diverse general-purpose or special-purpose computing systems. For example, the computing environment 100 can be any of a variety of computing devices (e.g., desktop computer, laptop computer, server computer, tablet computer, etc.)

With reference to FIG. 7, the computing environment 100 includes one or more processing units 110, 115 and memory 120, 125. In FIG. 7, this basic configuration 1030 is included within a dashed line. The processing units 110, 115 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 110 as well as a graphics processing unit or co-processing unit 115. The tangible memory 120, 125 may be volatile memory (e.g., registers, cache, RAM), non-volatile memory (e.g., ROM, EEPROM, flash memory, etc.), or some combination of the two, accessible by the processing unit(s). The memory 120, 125 stores software 180 implementing one or more innovations described herein, in the form of computer-executable instructions suitable for execution by the processing unit(s).

A computing system may have additional optional features. For example, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The tangible storage 140 may be removable or non-removable, and includes magnetic disks, magnetic tapes or cassettes, CD-ROMs, DVDs, or any other medium which can be used to store information in a non-transitory way and which can be accessed within the computing environment 100. The storage 140 stores instructions for the software 1080 implementing one or more innovations described herein.

The input device(s) 150 may be a touch input device such as a keyboard, mouse, pen, or trackball, a voice input device, a scanning device, or another device that provides input to the computing environment 100. The output device(s) 160 may be a display, printer, speaker, CD-writer, or another device that provides output from the computing environment 100.

The communication connection(s) 170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The described method steps may be performed in sequences different from those shown, including concurrently, unless explicitly stated otherwise. Figures may simplify or omit alternate use cases for clarity.

Any embodiment disclosed herein may be implemented as computer-executable instructions stored on one or more computer-readable media (e.g., flash memory, hard drives, RAM) and executed on computing devices such as smartphones, embedded systems, or cloud-based servers.

The implementation is not limited to specific programming languages or hardware platforms. Code may be written in C++, Java, Python, or other languages and executed on commercially available or custom hardware.

Alternatively, some or all functions may be implemented using hardware logic components such as FPGAs, ASICs, ASSPs, SOCs, or CPLDs.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

For clarity, only selected aspects of software implementations are described, and well-known details are omitted. The disclosed technology is not limited to specific programming languages or hardware. Terms like “configured to” or “able to” encompass components in active, inactive, or standby states, unless otherwise specified. The terms “comprising,” “including,” and “having” are used inclusively and do not exclude additional elements. “Or” is inclusive, meaning one, some, or all items in a list. The articles “a,” “an,” and “the” mean “one or more” unless specified otherwise. “At least one of” or “and/or” refers to any combination of listed items. The term “allow” includes permitting, instructing, enabling, or facilitating a specified action. The detailed description is illustrative, and variations that do not depart from the essence of the claimed invention are within its scope.

1. A method for controlling an autonomous charging device (ACD), the ACD configured to manipulate a vehicle charging connector and determine a pose of a vehicle charging inlet, and based on such pose determination, mating the charging connector into the vehicle charging inlet, the method comprising, by a controller, the following acts:
receiving information about the vehicle, wherein said information comprises at least one of an inlet feature parameter and a vehicle positioning parameter;
acquiring at least one of a preset inlet pose determination strategy and a preset mating strategy by inputting the received vehicle information into a predetermined model; and
controlling the ACD based, at least partly, on the acquired preset inlet pose determination strategy and/or preset mating strategy,
wherein the vehicle information is received prior to a visual determination of the inlet pose.

2. The method in accordance with claim 1, wherein the ACD comprises, or is in communication with, a computer vision unit and a camera with a field of view, configured to perform a visual determination of the inlet pose utilizing an image acquired by such camera.

3. The method in accordance with claim 1, wherein the preset inlet pose determination strategy comprises: conducting an inlet pose determination with the camera positioned at a first distance relative to the inlet; and conducting a subsequent inlet pose determination with the camera positioned at a second distance relative to the inlet wherein the second distance is smaller than the first distance.

4. The method in accordance with claim 1, wherein the preset inlet pose determination strategy comprises: adjusting a camera parameter as a function of the received vehicle information, wherein the camera parameter comprises at least one of a camera field of view, a camera orientation, a camera focus, a camera exposure, a camera zoom, or a combination thereof.

5. The method in accordance with claim 2, wherein the preset inlet pose determination strategy comprises: adjusting a number of inlet pose determination steps required by the computer vision unit when the vehicle positioning parameter is above or within a determined threshold.

6. The method in accordance with claim 1, wherein the preset inlet pose determination strategy comprises determining the pose of the vehicle charging inlet based on the vehicle positioning parameter and overriding one, more than one, or all inlet pose determination steps required by the computer vision unit when the vehicle positioning parameter is above or within a determined threshold.

7. The method in accordance with claim 1, wherein the preset mating strategy comprises positioning the vehicle charging connector in relation to the vehicle charging inlet based on at least one of an inlet feature parameter and an inlet positioning coordinate information, wherein the inlet feature parameter comprises at least one of a position of the vehicle inlet cover, an opening direction of the vehicle inlet cover and the presence of obstacles present within a volume surrounding the vehicle charging inlet.

8. The method in accordance with claim 1, wherein the preset mating strategy comprises adapting a mating motion based on an accuracy parameter representing an accuracy of the vehicle or inlet position coordinate data.

9. The method in accordance with claim 1, wherein the preset mating strategy comprises adapting a speed of the charging connector's movement towards the vehicle charging inlet based on a proximity and an orientation of the vehicle charging inlet with respect to the charging connector.

10. The method in accordance with claim 1, further comprising performing a compatibility check between at least one of the inlet feature parameter, the positioning parameter, and an ACD parameter, and providing a communication to be received by the vehicle about the compatibility check, wherein said communication comprises at least one of a charging request acceptance, a charging request rejection or an instruction comprising a corrective action.

11. The method in accordance claim 1 comprising providing a communication to be received by the vehicle comprising instructions to adjust the vehicle's position relative to the ACD.

12. The method in accordance with claim 11 wherein the instructions to adjust the vehicle's position relative to the ACD are based on the at least one of the inlet pose determination strategy and the mating strategy.

13. The method in accordance with claim 1, further comprising providing a communication to be received by the vehicle comprising information of a position of the ACD or any component thereof, within a clearance space, wherein the clearance space comprises a volume relative to the ACD in which a presence of the vehicle or a part thereof is restricted at a predetermined time.

14. The method in accordance with claim 1, further comprising providing a communication to be received by the vehicle, such communication comprising an indication that the vehicle may move into, or out of, such clearance space, wherein the vehicle may move into, or out of, such clearance space when the ACD or any component thereof is not within such clearance space.

15. The method in accordance with claim 1, further comprising providing a communication to be received by the vehicle, the communication comprising an indication to position the vehicle relative to a mating space of the ACD, wherein the mating space comprises a volume relative to the ACD where the ACD is able to mate the connector into the vehicle charging inlet.

16. The method in accordance with claim 1, wherein the inlet feature parameter comprises at least one inlet descriptive parameter and optionally a value or interval for such inlet descriptive parameter.

17. The method in accordance with claim 1, wherein the inlet feature parameter comprises at least one of: an inlet position within the vehicle; an inlet orientation relative to the vehicle; an opening status of the inlet cover; an opening direction of the inlet cover; an opening angle of the inlet cover; a workspace within an inlet housing for manipulation of the charging connector; a dimension of the inlet cover; or a volume surrounding the vehicle charging inlet in which the charging connector may be manipulated without encountering an obstacle.

18. The method in accordance with claim 1, wherein the vehicle positioning parameter comprises at least one of: an inlet positioning coordinate data; an accuracy parameter representing an accuracy of the vehicle's positioning relative to the ACD; an inlet vehicle positioning (parking) coordinate information at a moment prior to the mating; or a description of a volume or a region relative to the ACD, indicating an area where the ACD anticipates the vehicle inlet to be positioned at a moment prior to the mating.

19. The method in accordance with claim 1, wherein, after executing the pose determination strategy or the mating strategy, further vehicle information is received and a new pose determination strategy or the mating strategy is acquired.

20. The method in accordance with claim 1, wherein the mating strategy can be adjusted as a result of the inlet pose determination strategy, and vice versa.

21. A system for controlling an operation of an autonomous charging device ACD comprising a controller, the controller being configured to:
receive information about the vehicle, wherein said information comprises at least one of an inlet feature parameter and a vehicle positioning parameter;
acquire at least one of a preset inlet pose determination strategy and a preset mating strategy by inputting the received vehicle information into a predetermined model; and
control the ACD based, at least partly, on the acquired preset inlet pose determination strategy and preset mating strategy;
wherein the information about the vehicle is received prior to a visual determination of the inlet pose.

22. An autonomous charging device ACD comprising a system according to claim 21.

23. One or more computer-readable storage media comprising computer-executable instructions for operating an autonomous charging device (ACD) that, when executed, cause a computing system to perform a method comprising:
receiving information about the vehicle, wherein said information comprises at least one of an inlet feature parameter and a vehicle positioning parameter;
acquiring at least one of a preset inlet pose determination strategy and a preset mating strategy by inputting the received vehicle information into a predetermined model; and
controlling the ACD based, at least partly, on the acquired preset inlet pose determination strategy and preset mating strategy;
wherein the information about the vehicle is received prior to a visual determination of the inlet pose.
